(19) United States
(12) Patent Application Publication
(10) Pub. No.: US 2025/0149051 A1
(43) Pub. Date: May 8, 2025

(54) VOICE PROCESSING METHODS, APPARATUSES, COMPUTER DEVICES, AND COMPUTER-READABLE STORAGE MEDIA

(71) Applicant: NETEASE (HANGZHOU) NETWORK CO., LTD., Hangzhou, Zhejiang (CN)

(72) Inventors: Yang ZHANG, Hangzhou, Zhejiang (CN); Haoyue ZHAN, Hangzhou, Zhejiang (CN); Yue LIN, Hangzhou, Zhejiang (CN)

(73) Assignee: NETEASE (HANGZHOU) NETWORK CO., LTD., Hangzhou, Zhejiang (CN)

(21) Appl. No.: 18/555,406

(22) PCT Filed: Sep. 15, 2022
(86) PCT No.: PCT/CN2022/119157

§ 371 Date: Jan. 13, 2025

(30) Foreign Application Priority Data
Apr. 27, 2022 (CN) 202210455923.0

(51) Int. Cl. G10L 21/007; G10L 13/033; G10L 25/30

(52) U.S. Cl. CPC G10L 21/007; G10L 13/033; G10L 25/30

(57) ABSTRACT

A voice processing method includes: performing voice conversion processing based on a user voice of a target user and specified timbre information to obtain a specified converted voice having a specified timbre; training a voice conversion model based on the user voice of the target user and the specified converted voice to obtain a target voice conversion model; inputting a target text for voice synthesis and the specified timbre information into a voice synthesis model to generate an intermediate voice having the specified timbre; and performing voice conversion processing on the intermediate voice by the target voice conversion model to generate a target synthesized voice that matches a timbre of the target user.

This application claims priority to Chinese Patent Application No. 202210455923.0, filed in the Chinese Patent Office on Apr. 27, 2022, and entitled “VOICE PROCESSING METHODS, VOICE PROCESSING APPARATUSES, COMPUTER DEVICES, AND COMPUTER-READABLE STORAGE MEDIA”. The entire contents of both of which are hereby incorporated by reference for all purposes.

### TECHNICAL FIELD

The present disclosure relates to information processing technologies, and more particularly, to voice processing methods, voice processing apparatuses, computer devices, and computer-readable storage media.

### BACKGROUND

With the development of information technology and wide popularization and application of computer devices such as smartphones, tablets, and notebook computers, the computer devices are developed in a diversified and personalized direction. The computer devices have been able to synthesize a voice that is comparable to that of a real person, thereby enriching human-computer interaction experiences. For example, common voice processing technologies at present include voice synthesis, voice conversion, and voice cloning, and the like. The voice cloning refers to a technique in which a machine extracts timbre information from a voice provided by a user and synthesizes a voice using the timbre information. The voice cloning is an extension of voice synthesis technologies. Traditional voice synthesis achieves a conversion from text to voice on a fixed speaker, while the voice cloning further specifies a speaker's timbre. At present, the voice cloning has many practical scenarios. For example, when the voice cloning is applied in voice navigation or audio novels, a user can customize his/her own voice package by uploading voices, and navigate or read aloud novels with his/her own voices, so as to improve the fun of using the application.

In the prior art, generally, for personalized customization by voice cloning, a user needs to provide his/her recorded voice and a text corresponding to the voice so as to implement voice cloning. However, in a use scenario of voice cloning, there is possibility that the reading of the recorded voice is inconsistent with the text provided by the user, so that cleaning and correction operations may be required before voice model training.

### SUMMARY

### Technical Problem

Embodiments of the present disclosure provide voice processing methods, voice processing apparatuses, computer devices, and computer-readable storage media, which can solve problems of difficulty in obtaining a recorded voice provided by a user that is consistent with a content to be spoken, a high requirement on the user in voice recording, and affecting a user experience.

### Technical Solutions

In a first aspect, one or more embodiments of the present disclosure provide a voice processing method, including:
performing voice conversion processing based on a user voice of a target user and specified timbre information to obtain a specified converted voice having a specified timbre, wherein the specified timbre information is timbre information determined from a plurality of pieces of preset timbre information, and the specified converted voice is a user voice having the specified timbre;
training a voice conversion model based on the user voice and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

In a second aspect, one or more embodiments of the present disclosure provide a voice processing apparatus, including:
a first processing unit configured to perform voice conversion processing based on a user voice of a target user and specified timbre information to obtain a specified converted voice having a specified timbre, wherein the specified timbre information is timbre information determined from a plurality of pieces of preset timbre information, and the specified converted voice is a user voice having the specified timbre;
a training unit configured to train a voice conversion model based on the user voice and the specified converted voice to obtain a target voice conversion model;
a generation unit configured to input a target text for voice synthesis and the specified timbre information into a voice synthesis model to generate an intermediate voice having the specified timbre; and
a second processing unit configured to perform voice conversion processing on the intermediate voice by the target voice conversion model to generate a target synthesized voice that matches a timbre of the target user.

In some embodiments, the apparatus further includes:
a first obtaining subunit configured to obtain a language content feature and a prosodic feature from the user voice of the target user; and
a first processing subunit configured to perform the voice conversion processing based on the language content feature, the prosodic feature, and the specified timbre information to obtain the specified converted voice having the specified timbre.

In some embodiments, the apparatus further includes:
a second obtaining subunit configured to obtain a sample voice and a text and sample timbre information of the sample voice;
a first adjusting unit configured to adjust one or more model parameters of a preset voice model based on the sample voice and the text and the sample timbre information of the sample voice to obtain an adjusted preset voice model;
a second processing subunit configured to continue to obtain a next sample voice and a text and sample timbre information of the next sample voice in a training sample voice set, and execute an operation of adjusting the one or more model parameters of the preset voice synthesis model based on the sample voice and the text and the sample timbre information of the sample voice, until a training condition of the adjusted voice model satisfies a model training termination condition, to obtain a trained preset voice model as the voice synthesis model.

In some embodiments, the apparatus further includes:
a second adjusting unit configured to adjust one or more model parameters of a parallel voice conversion model based on the user voice and the specified converted voice, until a model training termination condition of the parallel voice conversion model is satisfied, to obtain a trained parallel voice conversion model as the target voice conversion model.

In some embodiments, the apparatus further includes:
a third obtaining subunit configured to obtain a training voice pair and preset timbre information corresponding to the training voice pair, wherein the training voice pair includes an original voice and an output voice, the original voice and the output voice are a same voice, and all voices in the training voice pair are voices in the training sample voice set; and
a third adjusting unit configured to adjust one or more model parameters of a non-parallel voice conversion model based on the original voice, the output voice, and the preset timbre information, until a model training termination condition of the non-parallel voice conversion model is satisfied, to obtain a trained non-parallel voice conversion model as a target non-parallel voice conversion model.

In some embodiments, the apparatus further includes:
a third processing subunit configured to perform language content extraction processing on the original voice by a language feature processor of the non-parallel voice conversion model to obtain a language content feature of the original voice;
a fourth processing subunit configured to perform prosody extraction processing on the original voice by a prosodic feature processor of the non-parallel voice conversion model to obtain a prosodic feature of the original voice; and
a fourth adjusting unit configured to adjust the one or more model parameters of the non-parallel voice conversion model based on the language content feature of the original voice, the prosodic feature of the original voice, the preset timbre information, and the output voice.

In some embodiments, the apparatus further includes:
a first generation subunit configured to perform language information filtering processing on the original voice, determine language information corresponding to the original voice, generate a first vector having a first specified length based on the language information, and take the first vector as the language content feature.

In some embodiments, the apparatus further includes:
a second generation subunit configured to perform prosody information filtering processing on the original voice, determine prosody information corresponding to the original voice, generate a second vector having a second specified length based on the prosody information, and take the second vector as the prosodic feature.

In some embodiments, the apparatus further includes:
a fifth processing subunit configured to perform language content extraction processing on the user voice by a language feature processor of the target non-parallel voice conversion model to obtain the language content feature of the user voice; and
a sixth processing subunit configured to perform prosody extraction processing on the user voice by a prosodic feature processor of the target non-parallel voice conversion model to obtain the prosodic feature of the user voice.

In some embodiments, the apparatus further includes:
an inputting subunit configured to input the language content feature of the user voice, the prosodic feature of the user voice, and the specified timbre information into the target non-parallel voice conversion model to generate the specified converted voice having the specified timbre.

In a third aspect, one or more embodiments of the present disclosure provide a computer device including a memory, a processor, and a computer program which is stored on the memory and may run on the processor, and the computer program is executed by the processor to implement any operation of a voice processing method.

In a fourth aspect, one or more embodiments of the present disclosure provide a computer-readable storage medium storing a computer program. When executed by a processor, the computer program implements any operation of a method for controlling game scenes.

### Beneficial Effects

Embodiments of the present disclosure provide voice processing methods, voice processing apparatuses, computer devices, and computer-readable storage media. By constructing a voice synthesis model and a non-parallel voice conversion model, a target text is synthesized into an intermediate voice of a specified timbre through the voice synthesis model, and after a user voice of a target user is obtained, the specified timbre of the intermediate voice is directly converted into a timbre of the user voice through a parallel voice conversion model to obtain a target synthesized voice, so that a voice cloning operation can be quickly performed, which makes an operation of the user when performing voice cloning simple and improves operation efficiency of the voice cloning effectively. In addition, the embodiments of the present disclosure can generate a corresponding parallel conversion model for the user voice. A plurality of users can share one voice synthesis model and one non-parallel voice conversion model, which simplifies a voice conversion model structure and lighten the voice conversion model, thereby reducing storage consumption of the voice conversion model to a computer device.

### BRIEF DESCRIPTION OF THE DRAWINGS

To describe technical solutions in the embodiments of the present disclosure more clearly, accompanying drawings required for describing the embodiments will be introduced briefly. It is apparent that the accompanying drawings in the following description are merely embodiments of the present disclosure, and other drawings may be obtained by those skilled in the art without involving any inventive effort.

FIG. 1 is a schematic diagram illustrating a scenario of a voice processing system according to some embodiments of the present disclosure.

FIG. 2 is a schematic flow chart of a voice processing method according to one or more embodiments of the present disclosure.

FIG. 3 is a schematic diagram illustrating training of a voice synthesis model according to one or more embodiments of the present disclosure.

FIG. 4 is a schematic diagram illustrating training of a non-parallel voice conversion model according to one or more embodiments of the present disclosure.

FIG. 5 is a schematic diagram illustrating application of the non-parallel voice conversion model according to one or more embodiments of the present disclosure.

FIG. 6 is a schematic diagram illustrating training of a parallel voice conversion model according to one or more embodiments of the present disclosure.

FIG. 7 is a schematic diagram illustrating application of the voice synthesis model according to one or more embodiments of the present disclosure.

FIG. 8 is a schematic diagram illustrating application of the parallel voice conversion model according to one or more embodiments of the present disclosure.

FIG. 9 is a schematic structural diagram of a voice processing apparatus according to one or more embodiments of the present disclosure.

FIG. 10 is a schematic structural diagram of a computer device according to one or more embodiments of the present disclosure.

### EMBODIMENTS OF THE INVENTION

Technical solutions in the embodiments of the present disclosure will be clearly and completely described below in connection with the accompanying drawings in the embodiments of the present disclosure. It is apparent that the described embodiments are only part of the embodiments of the present disclosure and not all of them. Based on the embodiments of the present disclosure, all other embodiments obtained by a person skilled in the art without involving any inventive effort are within the scope of the present disclosure.

The embodiments of the present disclosure provide voice processing methods, voice processing apparatuses, computer devices, and computer-readable storage media. Specifically, the voice processing method of the embodiments of the present disclosure may be performed by a computer device, which may be a terminal. The terminal may be a smartphone, a tablet computer, a notebook computer, a touch screen, a game machine, a Personal Computer (PC), a Personal Digital Assistant (PDA), or the like. The terminal may also include a client, which may be a video application client, a music application client, a game application client, a browser client with a game program, an instant messaging client, or the like.

Referring to FIG. 1, FIG. 1 is a schematic diagram illustrating a scenario of a voice processing system according to some embodiments of the present disclosure, including a computer device. The system may include at least one terminal, at least one server, and a network. The terminal held by a user may be connected to the server(s) of different games through the network. The terminal is any device having computing hardware capable of supporting and executing a software product corresponding to a game. In addition, the terminal has one or more multi-touch-sensitive screens, the one or more multi-touch-sensitive screens being configured to sense and obtain an input of touch or sliding operations performed by a user at a plurality of points of one or more touch screens. In addition, when the system includes a plurality of terminals, a plurality of servers, and a plurality of networks, different terminals may be connected to each other through different networks and different servers. The network may be a wireless network or a wired network. For example, the wireless network is a wireless local area network (WLAN), a local area network (LAN), a cellular network, a 2G network, a 3G network, a 4G network, a 5G network, or the like. In addition, different terminals may be connected to other terminals, the server(s), or the like using their own Bluetooth networks or hotspot networks.

The computer device may: obtain a language content feature and a prosodic feature from a user voice of a target user; perform voice conversion processing based on the language content feature, the prosodic feature, and specified timbre information to obtain a specified converted voice having a specified timbre; train a voice conversion model based on the user voice and the specified converted voice to obtain a target voice conversion model; input a target text for voice synthesis and the specified timbre information into a voice synthesis model to generate an intermediate voice having the specified timbre; and perform voice conversion processing on the intermediate voice by the target voice conversion model to generate a target synthesized voice that matches a timbre of the target user.

It should be noted that the schematic diagram illustrating a scenario of the voice processing system shown in FIG. 1 is merely an example. The voice processing system and the scenario described in the embodiments of the present disclosure are used to more clearly describe the technical solutions of the embodiments of the present disclosure, and do not constitute a limitation on the technical solutions provided in the embodiments of the present disclosure. A person having ordinary skills in the art would know that the technical solutions provided in the embodiments of the present disclosure are also applicable to similar technical problems as an evolution of the voice processing system and emergence of a new service scenario.

The embodiments of the present disclosure provide voice processing methods, apparatuses, computer devices, and computer-readable storage media. The voice processing methods may be used with the terminal, such as a smartphone, a tablet computer, a notebook computer, or a personal computer. The voice processing methods, apparatuses, terminals, and storage media will be described in detail below. It should be noted that a description order of the following embodiments is not intended to limit a preferred order of the embodiments.

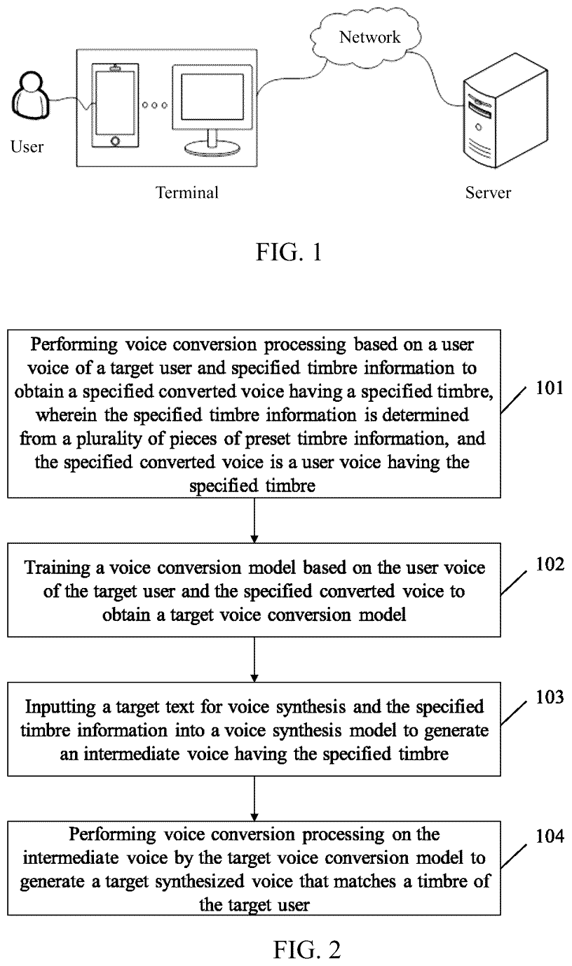

Referring to FIG. 2, FIG. 2 is a schematic flow chart of a voice processing method according to one or more embodiments of the present disclosure. The voice processing method may include the following operations 101 to 104.

In operation 101, voice conversion processing is performed based on a user voice of a target user and specified timbre information to obtain a specified converted voice having a specified timbre. The specified timbre information is timbre information determined from a plurality of pieces of preset timbre information, and the specified converted voice is a user voice having the specified timbre.

Before the operation of performing the voice conversion processing based on the user voice of the target user and the specified timbre information, the method includes:
obtaining a language content feature and a prosodic feature from the user voice of the target user.

The performing of the voice conversion processing based on the user voice of the target user and the specified timbre information includes:
performing the voice conversion processing based on the language content feature, the prosodic feature and the specified timbre information to obtain the specified converted voice having the specified timbre.

In one embodiment, before the operation of performing the voice conversion processing based on the language content feature, the prosodic feature, and the specified timbre information to obtain the specified converted voice having the specified timbre, the method may include:
obtaining a training voice pair and preset timbre information corresponding to the training voice pair, wherein the training voice pair includes an original voice and an output voice, the original voice and the output voice are a same voice, and all voices in the training voice pair are voices in the training sample voice set; and
adjusting one or more model parameters of a non-parallel voice conversion model based on the original voice, the output voice, and the preset timbre information, until a model training termination condition of the non-parallel voice conversion model is satisfied, to obtain a trained non-parallel voice conversion model as a target non-parallel voice conversion model.

Optionally, the operation of adjusting the one or more model parameters of the non-parallel voice conversion model based on the original voice, the output voice, and the preset timbre information may include:
performing language content extraction processing on the original voice by a language feature processor of the non-parallel voice conversion model to obtain a language content feature of the original voice;
performing prosody extraction processing on the original voice by a prosodic feature processor of the non-parallel voice conversion model to obtain a prosodic feature of the original voice; and
adjusting the one or more model parameters of the non-parallel voice conversion model based on the language content feature of the original voice, the prosodic feature of the original voice, the output voice, and the preset timbre information.

Specifically, the operation of performing the language content extraction processing on the original voice by the language feature processor of the non-parallel voice conversion model to obtain the language content feature of the original voice may include:
performing language information filtering processing on the original voice to determine language information corresponding to the original voice; and generating a first vector having a first specified length based on the language information, and taking the first vector as the language content feature.

In another specific embodiment, the operation of performing the prosody extraction processing on the original voice by the prosodic feature processor of the non-parallel voice conversion model to obtain the prosodic feature of the original voice may include:
performing prosody information filtering processing on the original voice to determine prosody information corresponding to the original voice; and generating a second vector having a second specified length based on the prosody information, and taking the second vector as the prosodic feature.

In an embodiment of the present disclosure, the operation of obtaining the language content feature and the prosodic feature from the user voice of the target user may include:
performing language content extraction processing on the user voice by a language feature processor of the target non-parallel voice conversion model to obtain the language content feature of the user voice; and
performing prosody extraction processing on the user voice by a prosodic feature processor of the target non-parallel voice conversion model to obtain the prosodic feature of the user voice.

In order to obtain the specified converted voice having the specified timbre, the operation of performing the voice conversion processing based on the language content feature, the prosodic feature, and the specified timbre information to obtain the specified converted voice having the specified timbre may include:
inputting the language content feature of the user voice, the prosodic feature of the user voice, and the specified timbre information into the target non-parallel voice conversion model to generate the specified converted voice having the specified timbre.

In operation 102, a voice conversion model is trained based on the user voice and the specified converted voice to obtain a target voice conversion model.

Specifically, the operation of training the voice conversion model based on the user voice and the specified converted voice to obtain the target voice conversion model may include:
adjusting one or more model parameters of a parallel voice conversion model based on the user voice and the specified converted voice, until a model training termination condition of the parallel voice conversion model is satisfied, to obtain a trained parallel voice conversion model, and taking the trained parallel voice conversion model as the target voice conversion model.

In operation 103, a target text for voice synthesis and the specified timbre information are inputted into a voice synthesis model to generate an intermediate voice having the specified timbre.

To obtain the voice synthesis model, before the operation of inputting the target text for voice synthesis and the specified timbre information into the voice synthesis model to generate the intermediate voice having the specified timbre, the method may include:
obtaining a sample voice and a respective text and sample timbre information of the sample voice; and
adjusting one or more model parameters of a preset voice model based on the sample voice and the text and the sample timbre information of the sample voice to obtain an adjusted preset voice model; and
continuing to obtain a next sample voice and a text and sample timbre information of the next sample voice in the training sample voice set, and executing an operation of adjusting the one or more model parameters of the preset voice synthesis model based on the sample voice and the text and the sample timbre information of the sample voice, until a training condition of the adjusted preset voice model satisfies a model training termination condition, to obtain a trained preset voice model as the voice synthesis model.

In operation 104, voice conversion processing is performed on the intermediate voice by the target voice conversion model to generate a target synthesized voice that matches the timbre of the target user.

In order to further describe the voice processing method provided in the embodiments of the present disclosure, application of the voice processing method in specific scenarios will be taken as examples for descriptions, and the specific application scenarios are as follows.
(1) The embodiments of the present disclosure provide a pre-training stage in which model training may be performed on the voice synthesis model and the non-parallel voice conversion model.

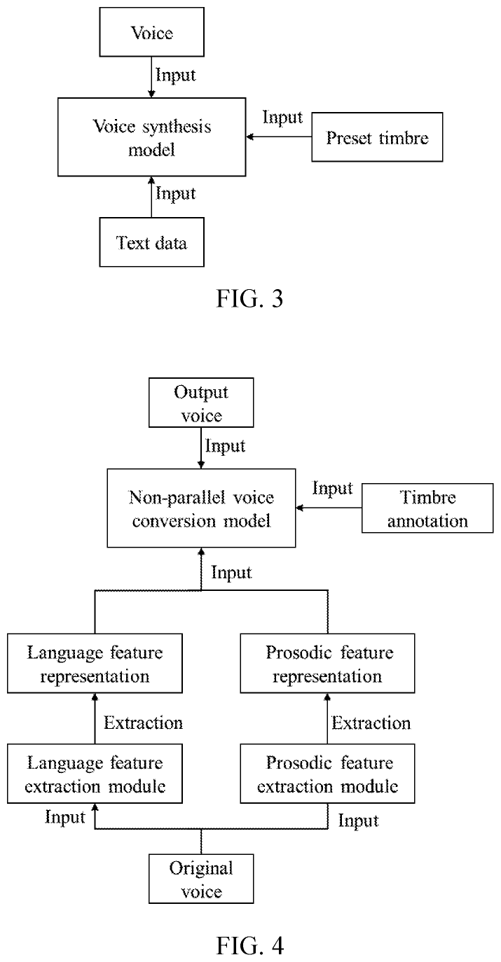

Referring to FIG. 3, FIG. 3 is a schematic diagram illustrating training of the voice synthesis model. During model training of the voice synthesis model, the voice synthesis model may be trained by using voices of a plurality of people that already exist in a database, texts corresponding to the voices of the plurality of people, and the preset timbre information. After being obtained, a trained voice synthesis model is saved for use in a model application stage. Specifically, the pre-training stage of the voice synthesis model is training a neural network model by inputting a large number of texts, voices, and timbre annotation data into the neural network model. The neural network model is generally based on an end-to-end deep neural network model. There may be many specific model structures to be selected, including but not limited to popular tacotron, fastspeech, or the like.

Referring to FIG. 4, FIG. 4 is a schematic diagram illustrating training of the non-parallel voice conversion model. During model training of the non-parallel voice conversion model, a trained language feature extraction module may be used to extract a language-related feature representation of the original voice, a prosodic feature module may be used to extract a prosodic-related feature representation of the original voice, and the language-related feature representation, the prosodic-related feature representation, a timbre annotation, and the output voice are inputted to the non-parallel voice conversion model for training.

The language feature extraction module aims to obtain a language feature representation independent of a timbre based on an input voice. The language feature extraction module may remove information independent of a language content in the voice, extract only language information, and convert the language information into a vector representation of a fixed length. The extracted language information should accurately reflect a voice content of the original voice without any errors or omissions. It should be noted that the language feature extraction module requires a neural network model to implement. There may be a lot of implementation ways. One of the implementation ways is to train a voice recognition model through a large number of voices and texts, and select an output of a specific hidden layer of the model as the language feature representation. Another way of the implementation ways is to compress and quantify a voice into representations of several voice units by an unsupervised training method (e.g., by using a Vector Quantised-Variational AutoEncoder (VQ-VAE) model), and restoring these voice units to the original voice. During this self-restoration training process, the quantified units gradually learn to become voice units independent of the timbre. The voice units are the language feature representation. The implementation ways may be other ways, and are not limited to the above two ways. In one embodiment, the voice prosodic feature extraction module aims to obtain a prosodic feature representation from the input voice and to convert the prosodic feature representation into a vector representation. The voice prosodic feature extraction module is to ensure that a voice generated after the conversion has a same prosody style as that of the original voice, so that data before and after the conversion are completely parallel except the timbre, which facilitates modelling of a parallel conversion model. The conversion may be technically implemented in multiple ways, and extraction is performed mainly through signal processing tools and algorithms, for example, by using common voice features such as frequency and energy. Optionally, a feature relating to voice emotion classification may be used.

In the embodiments of the present disclosure, the non-parallel voice conversion model aims to generate a converted voice corresponding to a timbre and a semantic content based on the language feature representation and the prosodic feature representation extracted from the user voice and a specified timbre annotation, and to construct parallel voice data for training the parallel conversion model. The non-parallel voice conversion model requires that the timbre of the converted voice is similar to that of the user voice of the target user, and the semantic content, prosody, or the like of the converted voice are completely consistent with those of the original voice. During the pre-training stage of the non-parallel voice conversion model, the language feature representation extracted by the language feature extraction model, the prosodic feature representation obtained by the prosodic feature extraction module, the timbre annotation, and the corresponding output voice are inputted into a neural network model for training. Generally, a deep neural network model is adopted. There are many specific model structures (e.g., a convolutional neural network, a recurrent neural network, a Transformer, or any combination thereof) that can be used to construct the non-parallel voice conversion model.
(2) The embodiments of the present disclosure provide a training stage of the parallel voice conversion model in which model training may be performed on the parallel voice conversion model.

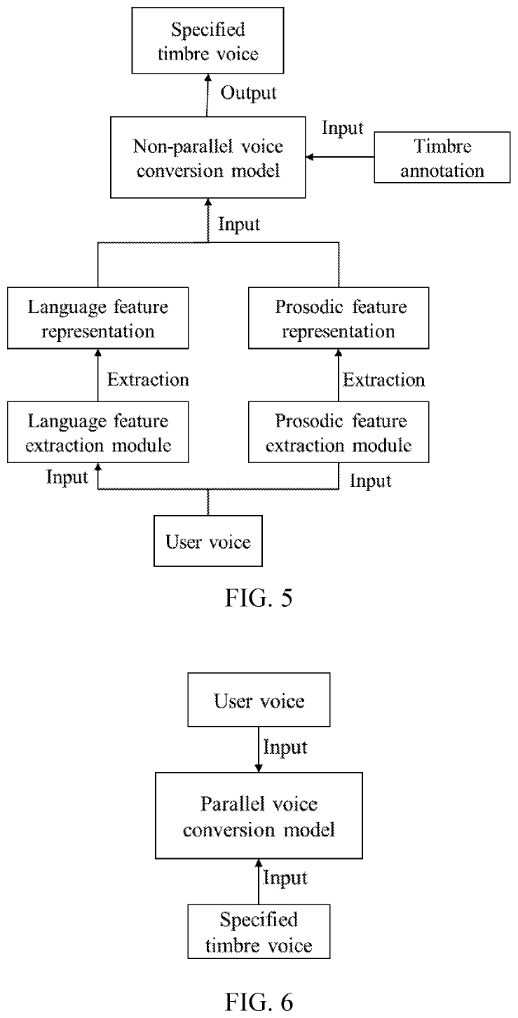

Referring to FIG. 5, FIG. 5 is a schematic diagram illustrating application of the non-parallel voice conversion model. When the user voice of the target user who needs voice cloning is determined, the non-parallel voice conversion model trained in the pre-training stage can be used to convert the user voice into a specified timbre voice, and a text content and prosodic information of the user voice remain unchanged. That is, a text content and prosodic information of the specified timbre voice after conversion are the same as the text content and prosodic information of the user voice, so as to construct the parallel voice data.

Referring to FIG. 6, FIG. 6 is a schematic diagram illustrating training of the parallel voice conversion model. After the specified timbre voice is obtained, a voice pair is formed based on the specified timbre voice and the user voice, and the specified timbre voice and the user voice are inputted into the parallel voice conversion model to perform model training on the parallel voice conversion model. The parallel voice conversion model may use a simple neutral network model, e.g., one-layer recurrent neural network or other model structures that may satisfy the above condition.
(3) The embodiments of the present disclosure provide a model application stage of the voice synthesis model and the parallel voice conversion model, and specific model application of the voice synthesis model and the parallel voice conversion model is as follows.

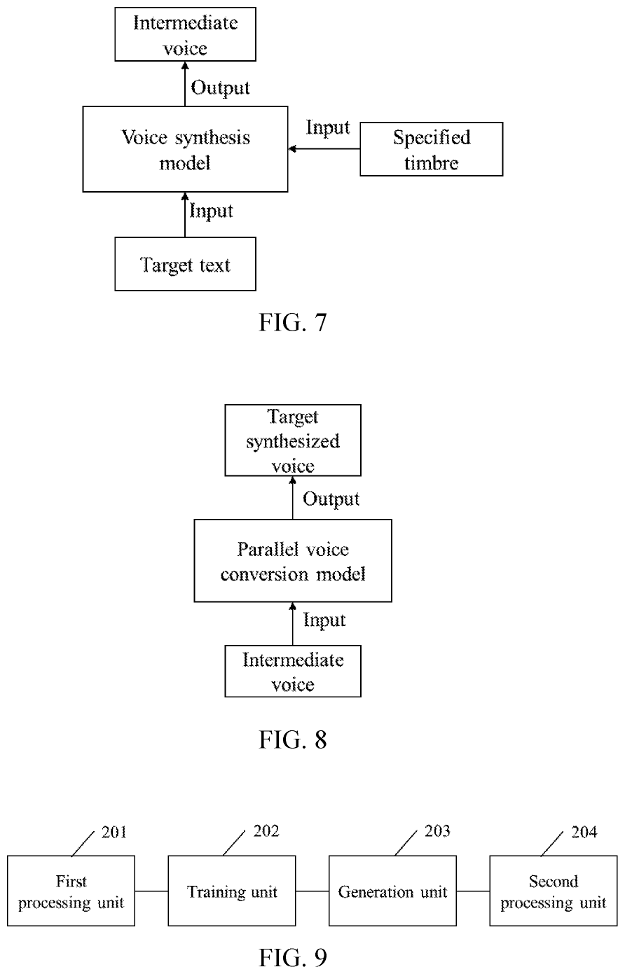

Referring to FIG. 7, FIG. 7 is a schematic diagram illustrating the application of the voice synthesis model. When it is detected that the voice cloning needs be performed on the target text based on the timbre of the user voice. The voice synthesis model may determine any text selected by the user as the target text, and convert the target text into the intermediate voice having the specified timbre.

Referring to FIG. 8, FIG. 8 is a schematic diagram illustrating application of the parallel voice conversion model. The parallel voice conversion model converts the intermediate voice having the specified timbre into the timbre corresponding to the user voice to obtain the target synthesized voice.

In summary, the embodiments of the present disclosure provide the voice processing method: constructing the voice synthesis model, the non-parallel voice conversion model, and the parallel voice conversion model; synthesizing the target text into the intermediate voice having the specified timbre into the intermediate voice having the specified timbre through the voice synthesis model shared by a plurality of users; after the user voice of the target user is obtained, directly converting the specified timbre of the intermediate voice into the timbre of the user voice to obtain the target synthesized voice through the parallel voice conversion model, so that a voice cloning operation can be quickly performed, which makes an operation of the user for the voice cloning simple and improves operation efficiency of the voice cloning.

Referring to FIG. 9, FIG. 9 is a schematic structural diagram of a voice processing apparatus according to one or more embodiments of the present disclosure. The apparatus includes:
a first processing unit 201 configured to perform voice conversion processing based on a user voice of a target user and specified timbre information to obtain a specified converted voice having a specified timbre, wherein the specified timbre information is timbre information determined from a plurality of pieces of preset timbre information, and the specified converted voice is a user voice having the specified timbre;
a training unit 202 configured to train a voice conversion model based on the user voice and the specified converted voice to obtain a target voice conversion model;
a generation unit 203 configured to input a target text for voice synthesis and the specified timbre information into a voice synthesis model to generate an intermediate voice having the specified timbre; and
a second processing unit 204 configured to perform voice conversion processing on the intermediate voice by the target voice conversion model to generate a target synthesized voice that matches a timbre of the target user.

In some embodiments, the apparatus further includes:
a first obtaining subunit configured to obtain a language content feature and a prosodic feature from the user voice of the target user; and
a first processing subunit configured to perform the voice conversion processing based on the language content feature, the prosodic feature, and the specified timbre information to obtain the specified converted voice having the specified timbre.

In some embodiments, the apparatus further includes:
a second obtaining subunit configured to obtain s a sample voice and a text and sample timbre information of the sample voice;
a first adjusting unit configured to adjust one or more model parameters of a preset voice model based on the sample voice and the text and the sample timbre information of the sample voice to obtain an adjusted preset voice model;
a second processing subunit configured to continue to obtain a next sample voice and a text and sample timbre information of the next sample voice in the training sample voice set, and execute an operation of adjusting the one or more model parameters of the preset voice synthesis model based on the sample voice and the text and the sample timbre information of the sample voice, until a training condition of the adjusted voice model satisfies a model training termination condition, to obtain a trained preset voice model as the voice synthesis model.

In some embodiments, the apparatus further includes:
a second adjusting unit configured to adjust one or more model parameters of a parallel voice conversion model based on the user voice and the specified converted voice, until a model training termination condition of the parallel voice conversion model is satisfied, to obtain a trained parallel voice conversion model, and take the trained parallel voice conversion model as the target voice conversion model.

In some embodiments, the apparatus further includes:
a third obtaining subunit configured to obtain a training voice pair and preset timbre information corresponding to the training voice pair, wherein the training voice pair includes an original voice and an output voice, the original voice and the output voice are a same voice, and all voices in the training voice pair are voices in the training sample voice set; and
a third adjusting unit configured to adjust one or more model parameters of a non-parallel voice conversion model based on the original voice, the output voice, and the preset timbre information, until a model training termination condition of the non-parallel voice conversion model is satisfied, to obtain a trained non-parallel voice conversion model as a target non-parallel voice conversion model.

In some embodiments, the apparatus further includes:
a third processing subunit configured to perform language content extraction processing on the original voice by a language feature processor of the non-parallel voice conversion model to obtain a language content feature of the original voice;
a fourth processing subunit configured to perform prosody extraction processing on the original voice by a prosodic feature processor of the non-parallel voice conversion model to obtain a prosodic feature of the original voice; and
a fourth adjusting unit configured to adjust the one or more model parameters of the non-parallel voice conversion model based on the language content feature of the original voice, the prosodic feature of the original voice, the preset timbre information, and the output voice.

In some embodiments, the apparatus further includes:
a first generation subunit configured to perform language information filtering processing
on the original voice to determine language information corresponding to the original voice, generate a first vector having a first specified length based on the language information, and take the first vector as the language content feature.

In some embodiments, the apparatus further includes:
a second generation subunit configured to perform prosody information filtering processing on the original voice to determine prosody information corresponding to the original voice, generate a second vector having a second specified length based on the prosody information, and take the second vector as the prosodic feature.

In some embodiments, the apparatus further includes:
a fifth processing subunit configured to perform language content extraction processing on the user voice by a language feature processor of the target non-parallel voice conversion model to obtain the language content feature of the user voice; and
a sixth processing subunit configured to perform prosody extraction processing on the user voice by a prosodic feature processor of the target non-parallel voice conversion model to obtain the prosodic feature of the user voice.

In some embodiments, the apparatus further includes:
an inputting subunit configured to input the language content feature of the user voice, the prosodic feature of the user voice, and the specified timbre information into the target non-parallel voice conversion model to generate the specified converted voice having the specified timbre.

The embodiments of the present disclosure provides a voice processing apparatus, wherein: the first processing unit 201 performs the voice conversion processing based on the user voice of the target user and the specified timbre information to obtain the specified converted voice having the specified timbre, wherein the specified timbre information is the timbre information determined from the plurality of pieces of preset timbre information, and the specified converted voice is the user voice having the specified timbre; the training unit 202 trains the voice conversion model based on the user voice and the specified converted voice to obtain the target voice conversion model; the generation unit 203 inputs the target text for voice synthesis and the specified timbre information into the voice synthesis model to generate the intermediate voice having the specified timbre; and the second processing unit 204 performs the voice conversion processing on the intermediate voice by the target voice conversion model to generate the target synthesized voice that matches the timbre of the target user. The embodiment of the present disclosure construct the voice synthesis model, the non-parallel voice conversion model, and the parallel voice conversion model, synthesize the target text into the intermediate voice having the specified timbre through the voice synthesis model, and after the user voice of the target user is obtained, directly convert the specified timbre of the intermediate voice into the timbre of the user voice through the parallel voice conversion model to obtain the target synthesized voice, so that a voice cloning operation can be quickly performed, which makes an operation of the user for the voice cloning simple and improves operation efficiency of the voice cloning effectively. In addition, the embodiments of the present disclosure can generate the corresponding parallel conversion model for the user voice. A plurality of users can share one non-parallel voice conversion model, which simplifies a voice conversion model structure and lighten the voice conversion model, thereby reducing storage consumption of the voice conversion model to a computer device.

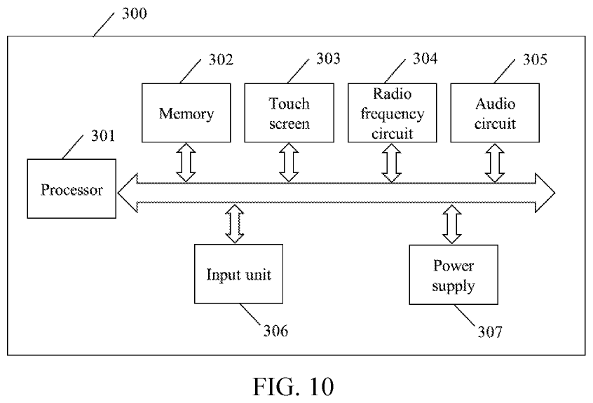

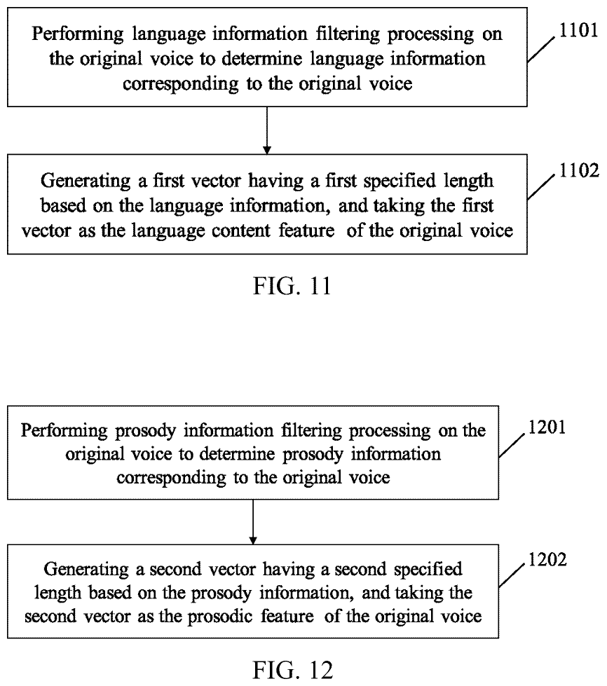

Accordingly, the embodiments of the present disclosure further provide a computer device. The computer device may be a terminal or a server. The terminal may be a smartphone, a tablet computer, a notebook computer, a touch screen, a game machine, a Personal Computer (PC), a Personal Digital Assistant (PDA), or the like. As shown in FIG. 10, FIG. 10 is a schematic structural diagram of a computer device according to one or more embodiments of the present disclosure. The computer device 300 includes a processor 301 having one or more processing cores, a memory 302 having one or more computer-readable storage media, and a computer program stored on the memory 302 and operable on the processor. The processor 301 is electrically connected to the memory 302. It will be appreciated by those skilled in the art that a computer device structure illustrated in the figure does not constitute a limitation on the computer device, and may include more or less components than illustrated, or may combine some components, or has different component arrangements.

The processor 301 is a control centre of the computer device 300, connects various parts of the computer device 300 by various interfaces and lines, and performs various functions of the computer device 300 and processes data by running or loading software programs and/or modules stored in the memory 302 and invoking data stored in the memory 302, thereby monitoring the computer device 300 as a whole.

In the embodiments of the present disclosure, the processor 301 in the computer device 300 loads instructions corresponding to processes of one or more application programs into the memory 302 according to the following operations, and runs the application programs stored in the memory 302 to implement various functions:
performing voice conversion processing based on a user voice of a target user and specified timbre information to obtain a specified converted voice having a specified timbre, wherein the specified timbre information is timbre information determined from a plurality of pieces of preset timbre information, and the specified converted voice is a user voice having the specified timbre;
training a voice conversion model based on the user voice and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

In one embodiment, before performing the voice conversion processing based on the user voice of the target user and the specified timbre information, the operations further include:
obtaining a language content feature and a prosodic feature from the user voice of the target user;
the performing the voice conversion processing based on the user voice of the target user and the specified timbre information includes:
performing the voice conversion processing based on the language content feature, the prosodic feature and the specified timbre information to obtain the specified converted voice having the specified timbre.

In one embodiment, before inputting the target text for voice synthesis and the specified timbre information into the voice synthesis model to generate the intermediate voice having the specified timbre, the operations further include:
obtaining a sample voice and a text and sample timbre information of the sample voice;
adjusting one or more model parameters of a preset voice model based on the sample voice and the text and the sample timbre information of the sample voice to obtain an adjusted preset voice model; and
continuing to obtain a next sample voice and a text and sample timbre information of the next sample voice in the training sample voice set, and executing an operation of adjusting the model parameters of the preset voice synthesis model based on the sample voice and the text and the sample timbre information of the sample voice, until a training condition of the adjusted voice model satisfies a model training termination condition, to obtain a trained preset voice model as the voice synthesis model.

In one embodiment, the training of the voice conversion model based on the user voice and the specified converted voice to obtain the target voice conversion model includes:
adjusting one or more model parameters of a parallel voice conversion model based on the user voice and the specified converted voice, until a model training termination condition of the parallel voice conversion model is satisfied, to obtain a trained parallel voice conversion model, and taking the trained parallel voice conversion model as the target voice conversion model.

In one embodiment, before performing the voice conversion processing based on the language content feature, the prosodic feature, and the specified timbre information to obtain the specified converted voice having the specified timbre, the operations further include:
obtaining a training voice pair and preset timbre information, wherein the training voice pair includes an original voice and an output voice, the original voice and the output voice are a same voice; and
adjusting one or more model parameters of a non-parallel voice conversion model based on the original voice, the output voice, and the preset timbre information, until a model training termination condition of the non-parallel voice conversion model is satisfied, to obtain a trained non-parallel voice conversion model as a target non-parallel voice conversion model.

In one embodiment, the adjusting of the one or more model parameters of the non-parallel voice conversion model based on the original voice, the output voice, and the preset timbre information includes:
performing language content extraction processing on the original voice by a language feature processor of the non-parallel voice conversion model to obtain a language content feature of the original voice;
performing prosody extraction processing on the original voice by a prosodic feature processor of the non-parallel voice conversion model to obtain a prosodic feature of the original voice; and
adjusting the one or more model parameters of the non-parallel voice conversion model based on the language content feature of the original voice, the prosodic feature of the original voice, the preset timbre information, and the output voice.

In one embodiment, the performing of the language content extraction processing on the original voice by the language feature processor of the non-parallel voice conversion model to obtain the language content feature of the original voice includes:
performing language information filtering processing on the original voice to determine language information corresponding to the original voice; and
generating a first vector having a first specified length based on the language information, and taking the first vector as the language content feature of the original voice.

In one embodiment, the performing of the prosody extraction processing on the original voice by the prosodic feature processor of the non-parallel voice conversion model to obtain the prosodic feature of the original voice includes:
performing prosody information filtering processing on the original voice, to determine prosody information corresponding to the original voice, generating a second vector having a second specified length based on the prosody information, and taking the second vector as the prosodic feature of the original voice.

In one embodiment, the obtaining of the language content feature and the prosodic feature from the user voice of the target user includes:
performing language content extraction processing on the user voice by a language feature processor of the target non-parallel voice conversion model to obtain the language content feature of the user voice; and
performing prosody extraction processing on the user voice by a prosodic feature processor of the target non-parallel voice conversion model to obtain the prosodic feature of the user voice.

In one embodiment, the performing of the voice conversion processing based on the language content feature, the prosodic feature, and the specified timbre information to obtain the specified converted voice having the specified timbre includes:
inputting the language content feature of the user voice, the prosodic feature of the user voice, and the specified timbre information into the target non-parallel voice conversion model to generate the specified converted voice having the specified timbre.

Detailed implementation of the above operations may be referred to aforementioned embodiments, and will not be repeated herein.

Optionally, as shown in FIG. 10, the computer device 300 further includes a touch screen 303, a radio frequency circuit 304, an audio circuit 305, an input unit 306, and a power supply 307. The processor 301 is electrically connected to the touch screen 303, the radio frequency circuit 304, the audio circuit 305, the input unit 306, and the power supply 307, respectively. It will be appreciated by those skilled in the art that the computer device structure shown in FIG. 10 does not constitute a limitation on the computer device, and may include more or fewer components than illustrated, or may combine some components, or has different component arrangements.

The touch screen 303 may be configured to display a graphical user interface and to receive operational instructions generated by a user acting on the graphical user interface. The touch screen 303 may include a display panel and a touch panel. The display panel may be used to display information input by or provided to the user and various graphical user interfaces of the computer device, which may be composed of graphics, text, icons, videos, and any combination thereof. Alternatively, the display panel may be configured in a form of a Liquid Crystal Display (LCD), an Organic Light-Emitting Diode (OLED), or the like. The touch panel may be used to collect a touch operation (e.g., an operation of the user on or near the touch panel using any suitable object or accessory such as a finger, a stylus, etc.) of the user on or near the touch panel, and generate a corresponding operation instruction, and the operation instruction executes a corresponding program. Alternatively, the touch panel may include a touch detection device and a touch controller. The touch detection device detects a touch orientation of the user, detects a signal brought about by the touch operation, and transmits the signal to the touch controller. The touch controller receives touch information from the touch detection device and converts the touch information into contact coordinates, sends the contact coordinates to the processor 301, and can receive and execute commands sent from the processor 301. The touch panel may cover the display panel, and when the touch panel detects the touch operation on or near the touch panel, the touch panel transmits the touch operation to the processor 301 to determine a type of a touch event. Then, the processor 301 provides a corresponding visual output on the display panel according to the type of the touch event. In the embodiments of the present disclosure, the touch panel and the display panel may be integrated to the touch screen 303 to implement input and output functions. However, in some embodiments, the touch panel and the touch panel may be implemented as two separate components to implement the input and output functions. That is, the touch screen 303 may implement the input function as part of the input unit 306.

In the embodiments of the present disclosure, an application program is executed by the processor 301 to generate a graphical interface on the touch screen 303. The touch screen 303 is used to present the graphical interface and receive an operation instruction generated by the user acting on the graphical interface.

The radio frequency circuit 304 may be configured to transmit and receive radio frequency signals to establish wireless communication with a network device or other computer devices through wireless communication, and to transmit and receive signals between the network device or other computer devices.

The audio circuit 305 may be configured to provide an audio interface between the user and the computer device through a speaker and a microphone. The audio circuit 305 may transmit an electrical signal converted from received audio data to a loudspeaker, and the loudspeaker converts the electrical signal into a sound signal for output. On the other hand, the microphone converts a collected sound signal into an electrical signal, the audio circuit 305 receives and converts the electrical signal into audio data. The audio data is outputted to the processor 301 for processing, and the processed audio data is sent to, for example, another computer device through the radio frequency circuit 304, or the audio data is outputted to the memory 302 for further processing. The audio circuit 305 may also include an earplug jack to provide communication between a peripheral headset and the computer device.

The input unit 306 may be configured to receive input numbers, character information, or user characteristic information (e.g., fingerprints, iris, face information), and to generate keyboard, mouse, joystick, optical, or trackball signal input related to user settings and functional control.

The power supply 307 is configured to power various components of the computer device 300. Alternatively, the power supply 307 may be logically connected to the processor 301 through a power supply management system, so that functions such as charging, discharging, and power consumption management are managed through the power supply management system. The power supply 307 may further include one or more DC or AC power supplies, a recharging system, a power failure detection circuit, a power converter or inverter, a power status indicator, or any other component.

Although not shown in FIG. 10, the computer device 300 may also include a camera, a sensor, a wireless fidelity module, a Bluetooth module, and the like, and details are not described herein.

In the above-mentioned embodiments, the description of each embodiment has its own emphasis, and parts not described in detail in a certain embodiment may be referred to related description of other embodiments.

As can be seen from the above, the computer device provided in the embodiments of the present disclosure: performs the voice conversion processing based on the user voice of the target user and the specified timbre information to obtain the specified converted voice having the specified timbre, wherein the specified timbre information is the timbre information determined from the plurality of pieces of preset timbre information, and the specified converted voice is the user voice having the specified timbre; trains the voice conversion model based on the user voice and the specified converted voice to obtain the target voice conversion model; inputs the target text for voice synthesis and the specified timbre information into the voice synthesis model to generate the intermediate voice having the specified timbre; and performs the voice conversion processing on the intermediate voice by the target voice conversion model to generate the target synthesized voice that matches the timbre of the target user. The embodiments of the present disclosure construct the voice synthesis model, the non-parallel voice conversion model, and the parallel voice conversion model, synthesize the target text into the intermediate voice having the specified timbre through the voice synthesis model, and after the user voice of the target user is obtained, directly convert the specified timbre of the intermediate voice into the timbre of the user voice through the parallel voice conversion model to obtain the target synthesized voice, so that a voice cloning operation can be quickly performed, which makes an operation of the user for the voice cloning simple and improves operation efficiency of the voice cloning effectively. In addition, the embodiments of the present disclosure can generate the corresponding parallel conversion model for the user voice. A plurality of users can share one non-parallel voice conversion model, which simplifies a voice conversion model structure and lighten the voice conversion model, thereby reducing storage consumption of the voice conversion model to a computer device.

It will be appreciated by those of ordinary skill in the art that all or a portion of the operations of the various methods of the above-described embodiments may be performed by instructions, which may be stored in a computer-readable storage medium and loaded and executed by a processor, or may be performed by the instructions through controlling relevant hardware.

To this end, the embodiments of the present disclosure provide a computer-readable storage medium having stored therein a plurality of computer programs. The computer programs can be loaded by a processor to perform operations in any of the voice processing methods provided in embodiments of the present disclosure. For example, the computer programs may perform the following operations:
performing voice conversion processing based on a user voice of a target user and specified timbre information to obtain a specified converted voice having a specified timbre, wherein the specified timbre information is timbre information determined from a plurality of pieces of preset timbre information, and the specified converted voice is a user voice having the specified timbre;
training a voice conversion model based on the user voice and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

In one embodiment, before performing the voice conversion processing based on the user voice of the target user and the specified timbre information, the operations further include:
obtaining a language content feature and a prosodic feature from the user voice of the target user;
wherein the performing of the voice conversion processing based on the user voice of the target user and the specified timbre information includes:
performing the voice conversion processing based on the language content feature, the prosodic feature and the specified timbre information to obtain the specified converted voice having the specified timbre.

In one embodiment, before inputting the target text for voice synthesis and the specified timbre information into the voice synthesis model to generate the intermediate voice having the specified timbre, the operations further include:
obtaining a sample voice and a text and sample timbre information of the sample voice;
adjusting one or more model parameters of a preset voice model based on the sample voice and the text and the sample timbre information of the sample voice to obtain an adjusted preset voice model; and
continuing to obtain a next sample voice and a text and sample timbre information of the next sample voice in the training sample voice set, and executing an operation of adjusting the one or more model parameters of the preset voice synthesis model based on the sample voice and the text and the sample timbre information of the sample voice, until a training condition of the adjusted voice model satisfies a model training termination condition, to obtain a trained preset voice model as the voice synthesis model.

In one embodiment, the training of the voice conversion model based on the user voice and the specified converted voice to obtain the target voice conversion model includes:
adjusting one or more model parameters of a parallel voice conversion model based on the user voice and the specified converted voice, until a model training termination condition of the parallel voice conversion model is satisfied, to obtain a trained parallel voice conversion model, and taking the trained parallel voice conversion model as the target voice conversion model.

In one embodiment, before performing the voice conversion processing based on the language content feature, the prosodic feature, and the specified timbre information to obtain the specified converted voice having the specified timbre, the operations further include:
obtaining a training voice pair and preset timbre information, wherein the training voice pair includes an original voice and an output voice, the original voice and the output voice are a same voice; and
adjusting one or more model parameters of a non-parallel voice conversion model based on the original voice, the output voice, and the preset timbre information, until a model training termination condition of the non-parallel voice conversion model is satisfied, to obtain a trained non-parallel voice conversion model, and taking the trained non-parallel voice conversion model as a target non-parallel voice conversion model.

In one embodiment, the adjusting of the one or more model parameters of the non-parallel voice conversion model based on the original voice, the output voice, and the preset timbre information includes:
performing language content extraction processing on the original voice by a language feature processor of the non-parallel voice conversion model to obtain a language content feature of the original voice;
performing prosody extraction processing on the original voice by a prosodic feature processor of the non-parallel voice conversion model to obtain a prosodic feature of the original voice; and
adjusting the one or more model parameters of the non-parallel voice conversion model based on the language content feature of the original voice, the prosodic feature of the original voice, the preset timbre information, and the output voice.

In one embodiment, the performing of the language content extraction processing on the original voice by the language feature processor of the non-parallel voice conversion model to obtain the language content feature of the original voice includes:
performing language information filtering processing on the original voice to determine language information corresponding to the original voice; and
generating a first vector having a first specified length based on the language information, and taking the first vector as the language content feature.

In one embodiment, the performing of the prosody extraction processing on the original voice by the prosodic feature processor of the non-parallel voice conversion model to obtain the prosodic feature of the original voice includes:
performing prosody information filtering processing on the original voice, determining prosody information corresponding to the original voice, generating a second vector having a second specified length based on the prosody information, and taking the second vector as the prosodic feature.

In one embodiment, the obtaining of the language content feature and the prosodic feature from the user voice of the target user includes:
performing language content extraction processing on the user voice by a language feature processor of the target non-parallel voice conversion model to obtain the language content feature of the user voice; and
performing prosody extraction processing on the user voice by a prosodic feature processor of the target non-parallel voice conversion model to obtain the prosodic feature of the user voice.

In one embodiment, the performing of the voice conversion processing based on the language content feature, the prosodic feature, and the specified timbre information to obtain the specified converted voice having the specified timbre includes:
inputting the language content feature of the user voice, the prosodic feature of the user voice, and the specified timbre information into the target non-parallel voice conversion model to generate the specified converted voice having the specified timbre.

Detailed implementation of the above operations may be referred to aforementioned embodiments, and will not be repeated herein.

The storage medium may include a Read Only Memory (ROM), a Random Access Memory (RAM), a magnetic disk, an optical disk, or the like.

Due to the computer programs stored in the storage medium, the operations in any of the voice processing methods provided in the embodiments of the present disclosure may be executed. The embodiments of the present disclosure perform the voice conversion processing based on the user voice of the target user and the specified timbre information to obtain the specified converted voice having the specified timbre, wherein the specified timbre information is the timbre information determined from the plurality of pieces of preset timbre information, and the specified converted voice is the user voice having the specified timbre; train the voice conversion model based on the user voice and the specified converted voice to obtain the target voice conversion model; input the target text for voice synthesis and the specified timbre information into the voice synthesis model to generate the intermediate voice having the specified timbre; and perform the voice conversion processing on the intermediate voice by the target voice conversion model to generate the target synthesized voice that matches the timbre of the target user. The embodiment of the present disclosure construct the voice synthesis model, the non-parallel voice conversion model, and the parallel voice conversion model, synthesize the target text into the intermediate voice having the specified timbre through the voice synthesis model, and after the user voice of the target user is obtained, directly convert the specified timbre of the intermediate voice into the timbre of the user voice through the parallel voice conversion model to obtain the target synthesized voice, so that a voice cloning operation can be quickly performed, which makes an operation of the user for the voice cloning simple and improves operation efficiency of the voice cloning effectively. In addition, the embodiments of the present disclosure can generate the corresponding parallel conversion model for the user voice. A plurality of users can share one non-parallel voice conversion model, which simplifies a voice conversion model structure and lighten the voice conversion model, thereby reducing storage consumption of the voice conversion model to a computer device.

In the above-mentioned embodiments, the description of each embodiment has its own emphasis. For parts not described in detail in a certain embodiment, related description of other embodiments may be referred to.

Voice processing methods, voice processing apparatuses, computer devices, and computer-readable storage media provided in the embodiments of the present disclosure are introduced in detail, and the principles and embodiments of the present disclosure are described herein using specific examples. The description of the above embodiments merely aims to help to understand the technical solutions and the core concept of the present disclosure. It will be appreciated by those of ordinary skill in the art that modifications may still be made to the technical solutions described in the foregoing embodiments, or equivalents may be made to some of the technical features therein. However, these modifications or equivalents do not depart the essence of the corresponding technical solutions from the scope of the technical solutions of the embodiments of the present disclosure.

1. A voice processing method, comprising:
performing voice conversion processing based on a user voice of a target user and specified timbre information to obtain a specified converted voice having a specified timbre, wherein the specified timbre information is determined from a plurality of pieces of preset timbre information, and the specified converted voice is a user voice having the specified timbre;
training a voice conversion model based on the user voice of the target user and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

2. The voice processing method of claim 1, further comprising: obtaining a language content feature and a prosodic feature from the user voice of the target user,
wherein the performing of the voice conversion processing based on the user voice of the target user and the specified timbre information comprises:
performing the voice conversion processing based on the language content feature, the prosodic feature and the specified timbre information.

3. The voice processing method of claim 1, wherein the voice synthesis model is obtained by training a preset voice synthesis model using a training sample voice set, the training sample voice set comprising a plurality of sample voices and respective texts and sample timbre information of the sample voices.

4. The voice processing method of claim 1, wherein the training of the voice conversion model to obtain the target voice conversion model comprises:
training a parallel voice conversion model based on the user voice of the target user and the specified converted voice, and taking the trained parallel voice conversion model as the target voice conversion model.

5. The voice processing method of claim 2, further comprising:
obtaining a training voice pair and preset timbre information corresponding to the training voice pair, wherein the training voice pair comprises an original voice and an output voice both comprising a same voice of a training sample voice set; and
training a non-parallel voice conversion model based on the original voice, the output voice, and the preset timbre information corresponding to the training voice pair, and taking the trained non-parallel voice conversion model as a target non-parallel voice conversion model.

6. The voice processing method of claim 5, wherein the training of the non-parallel voice conversion model comprises:
performing language content extraction processing on the original voice by a language feature processor of the non-parallel voice conversion model to obtain a language content feature of the original voice;
performing prosody extraction processing on the original voice by a prosodic feature processor of the non-parallel voice conversion model to obtain a prosodic feature of the original voice; and
training the non-parallel voice conversion model based on the language content feature of the original voice, the prosodic feature of the original voice, the output voice, and the preset timbre information corresponding to the training voice pair.

7. The voice processing method of claim 6, wherein the performing of the language content extraction processing on the original voice comprises:
performing language information filtering processing on the original voice to determine language information corresponding to the original voice; and
generating a first vector having a first specified length based on the language information, and taking the first vector as the language content feature of the original voice.

8. The voice processing method of claim 6, wherein the performing of the prosody extraction processing on the original voice comprises:
performing prosody information filtering processing on the original voice to determine prosody information corresponding to the original voice; and
generating a second vector having a second specified length based on the prosody information, and taking the second vector as the prosodic feature of the original voice.

9. The voice processing method of claim 5, wherein the obtaining of the language content feature and the prosodic feature from the user voice of the target user comprises:
performing language content extraction processing on the user voice of the target user by a language feature processor of the target non-parallel voice conversion model to obtain the language content feature of the user voice of the target user; and
performing prosody extraction processing on the user voice of the target user by a prosodic feature processor of the target non-parallel voice conversion model to obtain the prosodic feature of the user voice of the target user.

10. The voice processing method of claim 9, wherein the performing of the voice conversion processing based on the language content feature, the prosodic feature and the specified timbre information comprises:
inputting the language content feature of the user voice of the target user, the prosodic feature of the user voice of the target user, and the specified timbre information into the target non-parallel voice conversion model to generate the specified converted voice having the specified timbre.

11. (canceled)

12. A computer device comprising a memory and a processor, the memory storing a computer program executable by the processor to perform operations comprising:
performing voice conversion processing based on a user voice of a target user and specified timbre information to obtain a specified converted voice having a specified timbre, wherein the specified timbre information is determined from a plurality of pieces of preset timbre information, and the specified converted voice is a user voice having the specified timbre;
training a voice conversion model based on the user voice of the target user and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

13. A non-transitory computer-readable storage medium storing a computer program executable by a processor to perform operations comprising:
performing voice conversion processing based on a user voice of a target user and specified timbre information to obtain a specified converted voice having a specified timbre, wherein the specified timbre information is determined from a plurality of pieces of preset timbre information, and the specified converted voice is a user voice having the specified timbre;
training a voice conversion model based on the user voice of the target user and the specified converted voice to obtain a target voice conversion model;
inputting a target text for voice synthesis and the specified timbre information into a voice synthesis model to generate an intermediate voice having the specified timbre; and
performing voice conversion processing on the intermediate voice by the target voice conversion model to generate a target synthesized voice that matches a timbre of the target user.

14. The voice processing method of claim 1, wherein the preset voice synthesis model comprises at least one of tacotron and fastspeech.

15. The voice processing method of claim 6, wherein the language feature processor is obtained by training a voice recognition model based on a plurality of sample voices and a plurality of texts respectively corresponding to the sample voices, and
the performing of the language content extraction processing on the original voice by the language feature processor of the non-parallel voice conversion model to obtain the language content feature of the original voice comprises:
inputting the original voice into the language feature processor, and determining an output of a specific hidden layer output of the voice recognition model as the language content feature of the original voice.

16. The voice processing method of claim 6, wherein the performing of the language content extraction processing on the original voice by the language feature processor of the non-parallel voice conversion model to obtain the language content feature of the original voice comprises:
compressing and quantifying the original voice into a plurality of voice units by using a Vector Quantised-Variational AutoEncoder model;
performing a self-restoration training process on the voice units to obtain a plurality of restored voice units independent of timbre; and
determining the restored voice units as the language content feature of the original voice.

17. The voice processing method of claim 6, wherein the performing of the prosody extraction processing on the original voice by the prosodic feature processor comprises: performing the prosody extraction processing on the original voice by the prosodic feature processor based on at least one of frequency, energy, and a feature relating to voice emotion classification.

18. The voice processing method of claim 5, wherein the non-parallel voice conversion model comprises at least one of a convolutional neural network, a recurrent neural network, a Transformer.

19. The computer device of claim 12, wherein the operation further comprises: obtaining a language content feature and a prosodic feature from the user voice of the target user,
wherein the performing of the voice conversion processing based on the user voice of the target user and the specified timbre information comprises:
performing the voice conversion processing based on the language content feature, the prosodic feature and the specified timbre information.

20. The computer device of claim 12, wherein the voice synthesis model is obtained by training a preset voice synthesis model using a training sample voice set, the training sample voice set comprising a plurality of sample voices and respective texts and sample timbre information of the sample voices.

21. The voice processing method of claim 12, wherein the training of the voice conversion model to obtain the target voice conversion model comprises:
training a parallel voice conversion model based on the user voice of the target user and the specified converted voice, and taking the trained parallel voice conversion model as the target voice conversion model.
